(19) United States
(12) Patent Application Publication
(10) Pub. No.: US 2004/0213134 A1
(43) Pub. Date: Oct. 28, 2004

(54) Optical pickup apparatus

(75) Inventors: Kyu Takada, Otsu-Shi (JP); Yuichiro Ori, Moriyama-Shi (JP); Junji Hashimura, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/624,285

(22) Filed: Jul. 22, 2003

(30) Foreign Application Priority Data
Apr. 24, 2003 (JP) 2003-120286

(51) Int. Cl. G11B 7/135

(52) U.S. Cl. 369/112.08

(57) ABSTRACT

An optical pickup apparatus has a diffractive optical element and an objective lens that focuses light beams of different wavelengths, namely a first wavelength λ1, a second wavelength λ2, and a third wavelength λ3, on an information recording surface formed on different types of recording medium, namely a first recording medium, a second recording medium, and a third recording medium, respectively. The diffractive optical element has a first diffractive surface that does not diffract the light beams of the first and third wavelengths λ1 and λ3 but that diffracts the light beam of the second wavelength λ2 and a second diffractive surface that does not diffract the light beams of the first and second wavelengths λ1 and λ2 but that diffracts the light beam of the third wavelength λ3.

This application is based on Japanese Patent Application No. 2003-120286 filed on Apr. 24, 2003, the contents of which are hereby incorporated by reference.

### BACKGROUND OF THE INVENTION

1. Field of the Invention

The present invention relates to an optical pickup apparatus for use in an optical disk apparatus such as an optical information recording apparatus or magneto-optical recording apparatus.

2. Description of the Prior Art

Some conventionally known optical pickup apparatuses can record information on and reproduce information from different types of recording medium. For example, a single optical pickup apparatus permits recording and reproduction of information on and from both a DVD and a CD. One way to make an optical pickup apparatus compatible with different types of recording medium is to use light of different wavelengths so that recording and reproduction of information is performed by the use of light of a wavelength suitable to each type of recording medium.

On the other hand, with the development of a DVD using a blue semiconductor laser as a new type of recording medium, in recent years, optical pickup apparatuses have increasingly been required to be compatible with this next-generation DVD as well as the conventional DVD and the CD. A conventionally proposed technique of recording and reproducing information on and from such three different types of recording medium with a single optical pickup apparatus uses a single diffractive surface to achieve compatibility with light of a wavelength λ1 for the next-generation DVD, light of a wavelength λ2 for the conventional DVD, and light of a wavelength λ3 for the CD (refer to Japanese Patent Application Laid-Open No. 2003-67972, for example).

Specifically, the diffractive surface is so designed that it does not diffract light of a wavelength λ1 but diffracts light of wavelengths λ2 and λ3. Moreover, the diffractive surface has a step-shaped section, with each step thereof corresponding to a phase difference of 1λ for the next-generation DVD, 0.625λ for the conventional DVD, and 0.52λ for the CD. Here, the symbol λ collectively represents the wavelengths of the light used for those different types of recording medium. The diffraction efficiency achieved for those different types of recording medium is 100%, 61%, and 44%, respectively.

However, a conventional construction like the one disclosed in Japanese Patent Application Laid-Open No. 2003-67972 mentioned above has the following disadvantages. First, it offers diffraction efficiency as low as 61% for the conventional DVD. Increasingly high recording and reproduction rates are sought in particular for the next-generation and conventional DVDs, and such low diffraction efficiency becomes a bottleneck in achieving higher rates.

Second, light of both wavelengths λ2 and λ3 is diffracted by a single diffractive surface. This makes it impossible to correct aberrations individually for those two kinds of light. Thus, the wavefront aberration as designed is as large as 0.047 λrms for light of a wavelength λ2 and 0.021 λrms for light of a wavelength λ3. In general, to obtain satisfactory optical focusing performance in an optical pickup apparatus, a wavefront accuracy equal to or lower than the Marechal limit, namely 0.07 λrms, is required. This needs to be achieved with allowances made for view-angle and fabrication-related errors, and therefore, in reality, the wavefront accuracy as designed needs to be equal to or lower than 0.02 λ.

### SUMMARY OF THE INVENTION

An object of the present invention is to provide an optical pickup apparatus that has a simple construction, that achieves compatibility with three different types of recording medium including a next-generation format, and that employs a diffractive optical element offering high diffraction efficiency and easy to fabricate.

To achieve the above object, according to one aspect of the present invention, an optical pickup apparatus is provided with: a diffractive optical element; and an objective lens that focuses light beams of different wavelengths, namely a first wavelength λ1, a second wavelength λ2, and a third wavelength λ3, on an information recording surface formed on different types of recording medium, namely a first recording medium, a second recording medium, and a third recording medium, respectively. Here, the diffractive optical element is provided with: a first diffractive surface that does not diffract the light beams of the first and third wavelengths λ1 and λ3 but that diffracts the light beam of the second wavelength λ2; and a second diffractive surface that does not diffract the light beams of the first and second wavelengths λ1 and λ2 but that diffracts the light beam of the third wavelength λ3.

According to another aspect of the present invention, an optical disk apparatus is provided with: a light source that oscillates light beams of different wavelengths, namely a first wavelength λ1, a second wavelength λ2, and a third wavelength λ3; a light integrator that makes the light beams of the first, second, and third wavelengths λ1, λ2, and λ3 exit therefrom in such a way as to proceed to travel along an common optical path; a diffractive optical element; and an objective lens that focuses the light beams of the first, second, and third wavelengths λ1, λ2, and λ3 on an information recording surface formed on different types of recording medium, namely a first recording medium, a second recording medium, and a third recording medium, respectively. Here, the diffractive optical element is provided with: a first diffractive surface that does not diffract the light beams of the first and third wavelengths λ1 and λ3 but that diffracts the light beam of the second wavelength λ2; and a second diffractive surface that does not diffract the light beams of the first and second wavelengths λ1 and λ2 but that diffracts the light beam of the third wavelength λ3.

According to another aspect of the present invention, a diffractive optical element disposed in the optical path of an optical pickup apparatus is provided with: a first diffractive surface that does not diffract light beams of first and third wavelengths λ1 and λ3 but that diffracts a light beam of a second wavelength λ2; and a second diffractive surface that does not diffract light beams of first and second wavelengths λ1 and λ2 but that diffracts a light beam of a third wavelength λ3.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a construction diagram schematically showing an optical pickup apparatus embodying the invention;

FIG. 2 is a sectional view schematically showing the construction of the diffractive optical element and the objective lens;

FIGS. 3A and 3B are diagrams showing sectional shapes of the diffractive optical element;

FIGS. 4A to 4C are diagrams illustrating the construction of the diffractive optical element;

FIG. 5 is a construction diagram of the embodiment; and

FIGS. 6A to 6C are wavefront aberration diagrams of the embodiment.

### DESCRIPTION OF THE PREFERRED EMBODIMENTS

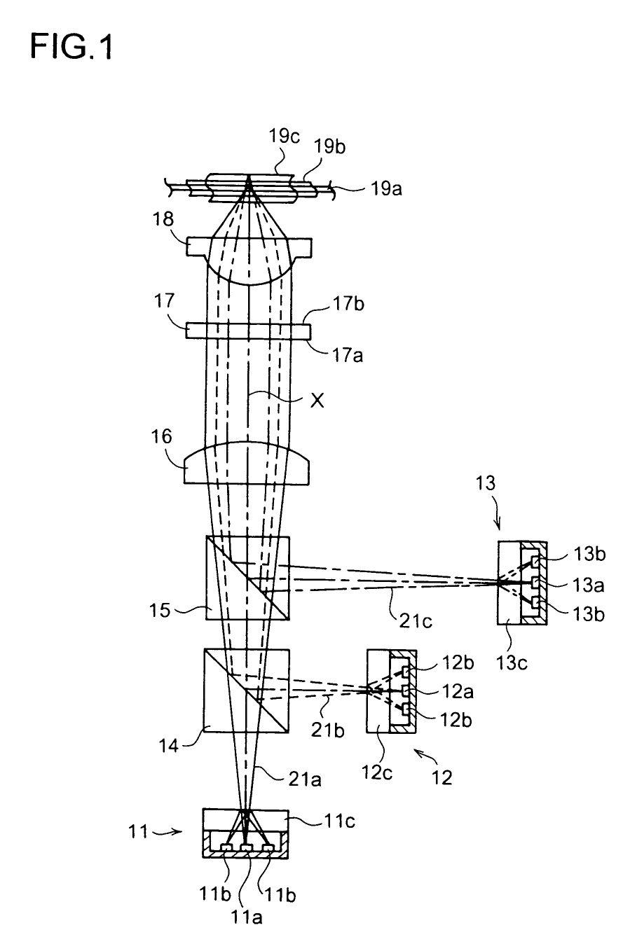

Hereinafter, embodiments of the invention will be described with reference to the drawings. FIG. 1 is a construction diagram schematically showing an optical pickup apparatus embodying the invention. In this figure, at the bottom thereof, there is shown a first semiconductor laser module 11, which has a casing in the shape of a bottomed box, at the center of the bottom thereof is disposed a first semiconductor laser 11a, with first photodetectors 11b disposed on both sides thereof. On the top face of the module 11, a first hologram 11c is disposed as if a lid thereof. The first semiconductor laser 11a emits upward as seen in the figure a light beam 21a (indicated by solid lines) of a wavelength λ1=405 nm.

Moreover, to the upper right side of the first semiconductor laser module 11, there is disposed a second semiconductor laser module 12, which has a casing in the shape of a bottomed box, at the center of the bottom thereof is disposed a second semiconductor laser 12a, with second photodecectors 12b disposed on both sides thereof. On the top face of the module 12, a second hologram 12c is disposed as if a lid thereof. The second semiconductor laser 12a emits leftward as seen in the figure a light beam 21b (indicated by broken lines) of a wavelength λ2=650 nm.

Furthermore, to the upper right side of the second semiconductor laser module 12, there is disposed a third semiconductor laser module 13, which has a casing in the shape of a bottomed box, at the center of the bottom thereof is disposed a third semiconductor laser 13a, with third photodecectors 13b disposed on both sides thereof. On the top face of the module 13, a third hologram 13c is disposed as if a lid thereof. The third semiconductor laser 13a emits leftward as seen in the figure a light beam 21c (indicated by dash-and-dot lines) of a wavelength λ3=780 nm. In this embodiment, a laser, a detector, and a hologram are built into a module. It is to be understood, however, that this is not meant to limit in any way how to carry out the invention; that is, the laser, detector, and hologram may be disposed separately.

The light beam 21a emitted from the first semiconductor laser 1a and the light beam 21b emitted from the second semiconductor laser 12a are integrated together by a substantially cube-shaped beam splitter 14 disposed at a position where the optical paths of the two beams cross each other. Thus, these two light beams proceed to travel along a common optical path, and come to have a common optical axis X that extend toward a recording medium. Furthermore, with these two light beams, the light beam 21c emitted from the third semiconductor laser 13a is also integrated by a substantially cube-shaped beam splitter 15 disposed at a position where its optical path crosses that of the light beams 21a and 21b. Thus, the three light beams proceed to travel along a common optical path, and come to have the common optical axis X.

Subsequently, the three light beams are converted into a parallel beam by a collimator lens 16 disposed above, and are then made to converge by a disk-shaped diffractive optical element 17 and an objective lens 18 disposed further above. The objective lens 18 is convex mainly downward as seen in the figure (in the direction opposite to the recording medium). The beam splitters 14 and 15 are optical elements that separate or synthesize light beams of different wavelengths by exploiting the wavelength selectivity of an interference film.

The light beam 21a of a wavelength λ1 emitted from the first semiconductor laser 11a is focused on the surface of a first type of recording medium 19a opposite to the entrance surface thereof. The light beam 21b of a wavelength %2 emitted from the second semiconductor laser 12a is focused on the surface of a second type of recording medium 19b opposite to the entrance surface thereof. The light beam 21c of a wavelength %3 emitted from the third semiconductor laser 13a is focused on the surface of a third type of recording medium 19c opposite to the entrance surface thereof.

Here, the first type of recording medium 19a is the next-generation DVD, of which the thickness from the external surface to the recording surface (i.e., the thickness of the cover layer) is 0.1 mm. The second type of recording medium 19b is the conventional DVD, of which the thickness from the external surface to the recording surface is 0.6 mm. The third type of recording medium 19c is the CD, of which the thickness from the external surface to the recording surface is 1.2 mm. In FIG. 1, for each of these types of recording medium, only the aforementioned thickness is shown. Needless to say, it is for convenience sake that the three types of recording medium 19a, 19b, and 19c are illustrated together in FIG. 1; in reality, one of those types of recording medium is used at a time.

The light beam 21a of a wavelength λ1 reflected from the first type of recording medium 19a travels its optical path backward to return to the first semiconductor laser module 11, where the light beam 21a has its optical path bent by the first hologram 11c so as to be incident on the first photodecectors 11b, which thus detect the light beam 21a as an optical signal. The light beam 21b of a wavelength λ2 reflected from the second type of recording medium 19b travels its optical path backward to return to the second semiconductor laser module 12, where the light beam 21b has its optical path bent by the second hologram 12c so as to be incident on the second photodecectors 12b, which thus detect the light beam 21b as an optical signal. The light beam 21c of a wavelength λ3 reflected from the third type of recording medium 19c travels its optical path backward to return to the third semiconductor laser module 13, where the light beam 21c has its optical path bent by the third hologram 13c so as to be incident on the third photodecectors 13b, which thus detect the light beam 21c as an optical signal.

The diffractive optical element 17 has a first diffractive surface 17a on the entrance side thereof, and has a second refractive surface 17b on the exit side thereof. The first diffractive surface 17a permits the light beams 21a and 21c of wavelengths λ1 and λ3 to pass therethrough straight without diffracting them, but diffracts the light beam 21b of a wavelength λ2. The second diffractive surface 17b permits the light beams 21a and 21b of wavelengths λ1 and λ2 to pass therethrough straight without diffracting them, but diffracts the light beam 21c of a wavelength λ3.

The objective lens 18 is so designed that, when the light beam 21a of a wavelength λ1 is shone into it in the form of a parallel beam, it is focused on the first type of recording medium 19a having a cover layer thickness of 0.1 mm. The light beam 21a of a wavelength λ1 is not diffracted by the diffractive optical element 17 but travels straight therethrough. Thus, this light beam, of which the wavefront remains unaffected, is focused satisfactorily on the first type of recording medium 19a by the objective lens 18. However, the light beam 21b of a wavelength λ2, which is focused on the second type of recording medium 19b having a cover layer thickness of 0.6 mm, suffers from spherical aberration resulting from differences in recording medium thickness and in wavelength.

To overcome this, the light beam 21b is diffracted by the first diffractive surface 17a of the diffractive optical element 17. This produces spherical aberration, and causes the diffracted light to form a divergent beam. Furthermore, this divergent beam is shone into the objective lens 18. This produces further spherical aberration. The spherical aberration so produced cancels out the spherical aberration resulting from differences in recording medium thickness and in wavelength.

Likewise, the light beam 21c of a wavelength %3, which is focused on the third type of recording medium 19c having a cover layer thickness of 1.2 mm, suffers from spherical aberration resulting from differences in recording medium thickness and in wavelength. To overcome this, the light beam 21c is diffracted by the second diffractive surface 17b of the diffractive optical element 17. This produces spherical aberration, and causes the diffracted light to form a divergent beam. Furthermore, this divergent beam is shone into the objective lens 18. This produces further spherical aberration. The spherical aberration so produced cancels out the spherical aberration resulting from differences in recording medium thickness and in wavelength.

As described above, the objective lens 18 is so designed that, when the light beam 21a of a wavelength λ1 is shone into it in the form of a parallel beam, it is focused on the first type of recording medium 19a having a cover layer thickness of 0.1 mm. Here, however, the distance between the objective lens 18 and the first type of recording medium 19a, i.e., the working distance of the objective lens 18, is short. Accordingly, if the light beams of wavelengths λ2 and λ3 are shone into the objective lens 18 intact, i.e., in the form of a parallel beam, it is impossible to secure a sufficient working distance because of the thicker cover layer thicknesses, namely 0.6 mm and 1.2 mm, of the second and third types of recording medium 19b and 19c. To overcome this, in this embodiment, the light beams of wavelengths λ2 and λ3 are converted into a divergent beam with a diffractive surface so as to make the back-focal length of the objective lens 18 longer and thereby secure a sufficient working distance.

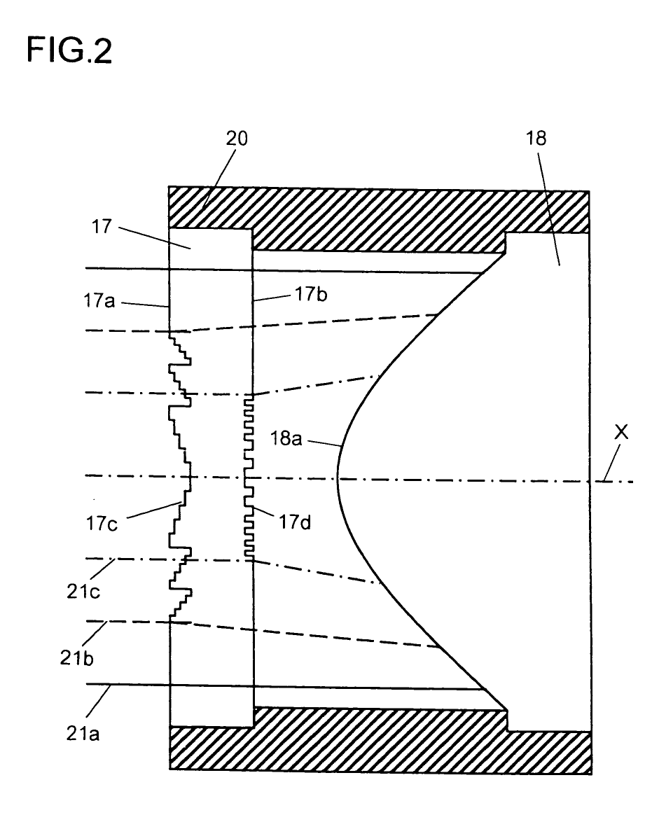

FIG. 2 is a sectional view schematically showing the construction of the diffractive optical element and the objective lens used in this embodiment. As shown in this figure, the diffractive optical element 17 and the objective lens 18 are coaxially held together by a lens barrel 20 so as to form a single unit. Specifically, the diffractive optical element 17 and the objective lens 18 are firmly fitted into one and the other end, respectively, of the cylindrical lens barrel 20 so as to be held together coaxially along the optical axis X and thereby form a single unit. The objective lens 18 has a lens surface 18a that is convex mainly toward the inside of the lens barrel 20.

When information is recorded on or reproduced from an optical disk, the objective lens 18 is controlled, through tracking control, so as to move within a range of about ±0.5 mm perpendicularly to the optical axis. When the light beam 21b or 21c of a wavelength λ2 or λ3 is used, however, since the light beam is diffracted by the diffractive optical element 17, if the objective lens 18 alone moves while the diffractive optical element 17 remains stationary, spherical aberration occurs, enlarging the focused spot.

To overcome this, as shown in FIG. 2, the diffractive optical element 17 and the objective lens 18 are built into a single unit, and are moved together for tracking control. This makes it possible to obtain a satisfactorily focused spot. The lens barrel 20 may be omitted. In that case, for example, a flange is provided on at least one of the diffractive optical element 17 and the objective lens 18, and these are built into a single unit directly by the use of the flange. That is, what is important here is that the diffractive optical element and the objective lens are held together in such a way that their positions relative to each other do not change.

The numerical aperture of the objective lens 18 is 0.85 for the next-generation DVD, for which light of a wavelength λ1 is used, 0.6 for the conventional DVD, for which light of a wavelength λ2 is used, and 0.45 for the CD, for which light of a wavelength λ3 is used. Moreover, as shown in FIG. 2, the light beams of wavelengths λ1, λ2, and λ3, when passing through the diffractive optical element 17, have decreasingly large beam diameters in the order in which they have just been mentioned.

On the first diffractive surface 17a, within the area in which the light beam 21b passes therethrough, there is formed, in the shape of concentric circles, a grating portion 17c having a step-shaped section. On the second diffractive surface 17b, within the area in which the light beam 21c passes therethrough, there is formed, in the shape of concentric circles, a grating portion 17d having a step-shaped section. The grating portion 17c has a repeated pattern of four steps, and the grating portion 17d has a repeated pattern of a single step. The first and second diffractive surfaces may be arranged in the opposite order.

The light beams 21a, 21b, and 21c of wavelengths λ1, λ2, and λ3 are all incident on the diffractive optical element 17 in the form of a parallel beam, i.e., not in the form of a divergent or convergent beam. This helps prevent coma from occurring when the diffractive optical element 17 and the objective lens 18 are decentered through tracking control during recording or reproduction of information on or from an optical disk.

In this embodiment, the first diffractive surface 17a diffracts, among the light beams of three different wavelengths, only that of a wavelength λ2. This makes it possible to correct aberrations for the light beam of a wavelength λ2 independently. Moreover, the second diffractive surface 17b diffracts, among the light beams of three different wavelengths, only that of a wavelength λ3. This makes it possible to correct aberrations for the light beam of a wavelength λ3 independently. In this way, it is possible to obtain very satisfactory focusing performance with any of the three types of recording medium mentioned above.

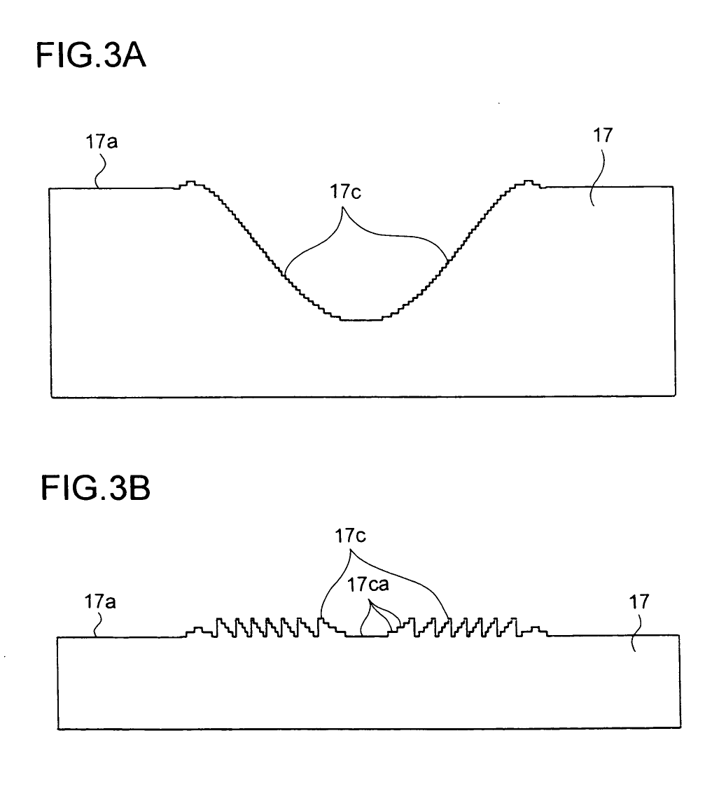

FIGS. 3A and 3B are diagrams showing the sectional shapes of the diffractive optical element. As described above, in this embodiment, the diffractive optical element have a portion, having a step-shaped section, formed in the shape of concentric circles. As shown in those figures, the grating portion 17c (or 17d) having a step-shaped section that is formed on the surface of the diffractive optical element 17 is formed either as shown in FIG. 3A or as shown in FIG. 3B.

In FIG. 3A, any two adjacent level surfaces differ in height by one step. This is called a continuous type. In FIG. 3B, every predetermined number (in the figure, five) of level surfaces 17ca of which each differs in height by one step from the next, level surfaces are shifted back by the corresponding number (in the figure, four) of steps. This is called a sawtooth type, after its shape. FIG. 2 shows a case where the sawtooth type is adopted.

The continuous and sawtooth types have their respective advantages and disadvantages in terms of their characteristics in response to variations in wavelength. Variations in wavelength result from variations among individual semiconductor lasers and variations in temperature. When there is a variation in wavelength, with the continuous type, although the wavefront slightly deviates from one step to the next, the wavefront is still smoothly continuous as a whole, causing no lowering of diffraction efficiency. However, the deviations of the wavefront cause aberrations. On the other hand, with the sawtooth type, even through the wavefront deviates from one step to the next, such deviations of the wavefront are discontinuous at where level surfaces are shifted back every predetermined number of steps. Thus, provided that the number of such shifts are sufficiently great, no aberrations occur on a macroscopic scale. However, the deviations of the wavefront at where level surfaces are shifted back cause lowering of diffraction efficiency.

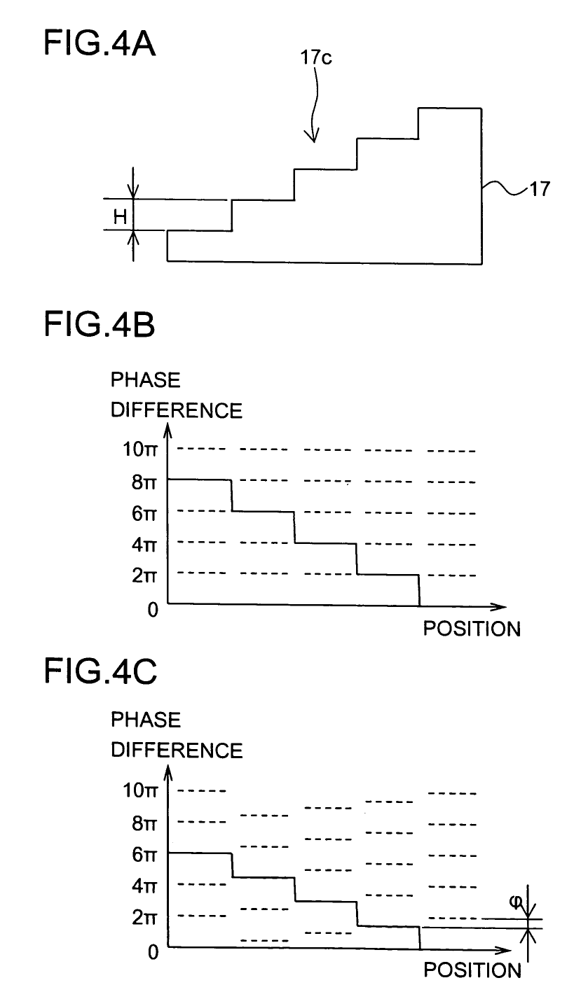

FIGS. 4A to 4C are diagrams illustrating the construction of the diffractive optical element of this embodiment. FIG. 4A is an enlarged view schematically showing the section of the grating portion 17c of the diffractive optical element 17, FIG. 4B shows the phase differences produced by the diffractive optical element 17 with respect to the wavelength λ1, and FIG. 4C shows the phase differences produced by the diffractive optical element 17 with respect to the wavelength λ2. In FIGS. 4B and 4C, the horizontal axis represents the same positional relationship as in the FIG. 4A.

Here, the following equations hold:

L1=λ1/(n1−1)

L2=λ2/(n2−1)

L3=λ3/(n3−1)

H=M·L1

where

L1 represents the height that produces an optical path difference equal to one wavelength of the light beam of a wavelength λ1;

L2 represents the height that produces an optical path difference equal to one wavelength of the light beam of a wavelength λ2;

L3 represents the height that produces an optical path difference equal to one wavelength of the light beam of a wavelength λ3;

n1 represents the refractive index of the diffractive optical element at the wavelength λ1;

n2 represents the refractive index of the diffractive optical element at the wavelength λ2;

n3 represents the refractive index of the diffractive optical element at the wavelength λ3;

M represents an integer equal to or greater than one; and

H represents the height of one step.

Here is a numerical example based on the equations noted above in this embodiment:

λ1=405 nm

λ2=650 nm

λ3=780 nm

n1=1.546061

n2=1.527360

n3=1.523617

L1=741.68 nm

L2=1232.56 nm

L3=1489.64 nm

First Diffractive Surface (M=2):

H/L1=2

H/L2=1.203 (≈1.2)

H/L3=0.996(≈1)

Second Diffractive Surface (M=5):

H/L1=5

H/L2=3.009 (3)

H L3=2.489 (2.5)

Here, with respect to the first diffractive surface, M=2, and the height H of one step is twice the wavelength λ1. Moreover, H is 0.996 times the wavelength λ3, and is therefore very close to one time the wavelength λ3. Thus, with either of these wavelengths, the produced optical path difference is an integral multiples thereof. Accordingly, the light beams of wavelengths λ1 and λ3, of which the wavefront remains unaffected, travel straight without being diffracted, resulting in diffraction efficiency of 100%. On the other hand, with the light beam of a wavelength λ2, the height H of one step is about 1.2 times the wavelength λ2, and thus the produced optical path difference is not an integral multiple thereof. Accordingly, this light beam is diffracted, resulting in diffraction efficiency of 87%. Here, the height H of one step is 1.483 μm.

With respect to the second diffractive surface, M=5, and the height H of one step is five times the wavelength λ1. Moreover, H is 3.009 times the wavelength λ2, and is therefore very close to three times the wavelength λ2. Thus, with either of these wavelengths, the produced optical path difference is an integral multiples thereof. Accordingly, the light beams of wavelengths λ1 and λ2, of which the wavefront remains unaffected, travel straight without being diffracted, resulting in diffraction efficiency of 100%. On the other hand, with the light beam of a wavelength λ3, the height H of one step is about 2.5 times the wavelength λ3, and thus the produced optical path difference is not an integral multiple thereof. Accordingly, this light beam is diffracted, resulting in diffraction efficiency of 42%. Here, the height H of one step is 3.708 μm.

Multiplying the diffraction efficiency of the first and second diffractive surfaces together gives diffraction efficiency of 100% for the next-generation DVD, for which the light beam of a wavelength λ1 is used, 87% for the conventional DVD, for which the light beam of a wavelength λ2 is used, and 42% for the CD, for which the light beam of a wavelength λ3 is used. High diffraction efficiency is sought to achieve higher recording and reproduction rates in particular for the next-generation and conventional DVDs, and the present invention helps achieve higher diffraction efficiency.

Now, as an example, why the light beam of a wavelength λ1 travels straight without being diffracted while the light beam of a wavelength λ2 is diffracted will be described with reference to FIGS. 4A to 4C. The phase differences produced by the diffractive optical element 17 shown in FIG. 4A when M=1 are shown in FIGS. 4B and 4C in the form of graphs. In FIGS. 4B and 4C, the horizontal axis represents the same positional relationship as in the FIG. 4A. FIG. 4B shows the phase differences produced for the light beam of a wavelength λ1. As the light beam passes through the diffractive optical element 17, phase differences of 2π per step are produced in each of the repeatedly occurring wavefronts of the light beam, of which one is indicated by a solid line as their representative. Such phase differences of 2π per step are produced also in other wavefronts as indicated by broken lines, and accordingly the wavefront resulting from one step is contiguous with the wavefront 2π apart therefrom that results from the next step. The resulting state is therefore substantially equivalent to the state where there are no phase differences. Thus, the light beam, of which the wavefront remains unaffected, is not diffracted.

FIG. 4C shows the phase differences produced for the light beam of a wavelength λ2. As the light beam passes through the diffractive optical element 17, phase differences of 2π/L2 per step are produced in each of the repeatedly occurring wavefronts of the light beam, of which one is indicated by a solid line as their representative. Such phase differences occur also in other wavefronts as indicated by broken lines. As will be understood from the figure, in this case, the phase difference of 2π·H/L2 is substantially equivalent to the phase difference φ that occurs between the closest wavefronts resulting from two adjacent steps. This phase difference diffracts the wavefront. In the case shown in the figure, the wavelength φ corresponds to 0.2 times the wavelength, and therefore five steps correspond to one wavelength.

Hereinafter, a practical example of the principal portion of the optical system used in an optical pickup apparatus embodying the invention will be presented with reference to its construction data, aberration diagrams, and other data. Table 1 shows the construction data of the practical example. In the construction data, surfaces are identified with their numbers as counted from the entrance side of the optical system. The diffractive optical element 17 is constituted by a first surface (r1) and a second surface (r2). The objective lens 18 is constituted by a third surface (r3) and a fourth surface (r4). The recording medium (19a, 19b, or 19c) is constituted by a fifth surface (r5) and a sixth surface (r6). All radii of curvature and axial distances are given in mm.

The symbol t1 represents the axial distance between the objective lens and the recording medium, and t2 represents the thickness from the external surface to the recording surface of the recording medium. The symbols N1 to N3 represent the refractive indices for the wavelengths λ1, λ2, and λ3, respectively, and νd represents the Abbe number for the d-line. It is to be noted that the values of N1 to N3 between the first and second surfaces are equal to the values of n1 to n3 noted earlier, respectively.

The third and fourth surfaces are aspherical surfaces, of which the surface shape is given by

z=(y²/R)/{1+√[1−(K+1)(y/R)²]}+A₄y⁴+A₆y⁶+A₈y⁸+A₁₀y¹⁰+A₁₂y¹²+A₁₄y¹⁴+A₁₆y¹⁶

wherein

z represents the aspherical surface shape (the distance from the vertex of the aspherical surface along the optical axis);

y represents the distance from the optical axis;

R represents the radius of curvature;

K represents the conic coefficient; and

A₄, A₆, A₈, A₁₀, A₁₂, A₁₄, and A₁₆ represent the aspherical coefficients.

The first and second surfaces are diffractive surfaces, of which the optical path difference function is given by

φ=B₂y²+B₄y⁴+B₆y⁶+B₈y⁸+B₁₀y¹⁰

wherein

φ represents the optical path difference function;

y represents the distance from the optical axis; and

B₂, B₄, B₆, B₈, and B₁₀ represent the diffractive coefficients.

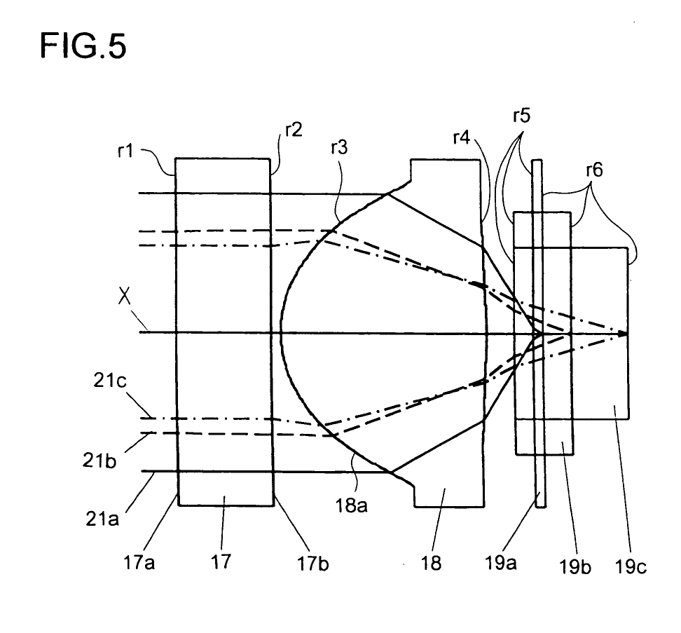

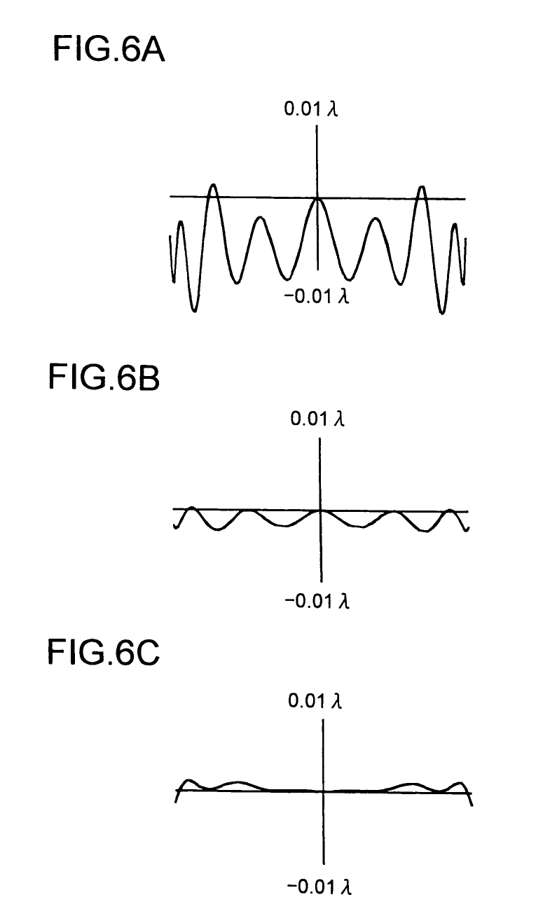

FIG. 5 is a construction diagram of the practical example, and FIGS. 6A to 6C are wavefront aberration diagrams thereof FIG. 6A shows the wavefront aberration observed with the next-generation DVD, FIG. 6B shows the wavefront aberration observed with the conventional DVD, and FIG. 6B shows the wavefront aberration observed with the CD. In each aberration diagram, the horizontal axis represents the range covering the maximum effective beam diameter, and the vertical axis represents the range covering ±0.01 times the wavelength.

In this practical example, as described earlier, it is possible to correct aberrations independently for light of wavelengths λ2 and λ3, and thus it is possible to obtain very satisfactory focusing performance with any of the three types of recording medium mentioned above. In this practical example, the wavefront aberration observed is as small as 0.005×rms (λ=λ1) with the next-generation DVD, 0.001 λrms (λ=λ2) with the conventional DVD, and 0.001 λ rms (λ=λ3) with the CD.

In an optical pickup apparatus, a wavefront accuracy equal to or lower than the Marechal limit, namely 0.07 λrms, is required, and this needs to be achieved with allowances made for view-angle and fabrication-related errors; that is, in reality, the wavefront accuracy as designed needs to be equal to or lower than 0.02 λrms. This practical example offers satisfactory performance, with a wavefront accuracy lower than that.

TABLE 1

| Practical Example | | | |
|---|---|---|---|
| Wavelengths (nm): | λ1 = 405 | λ2 = 650 | λ3 = 780 |
| Entrance Pupil Diameter (mm): | 3.00 | 2.17 | 1.86 |
| Numerical Aperture: | 0.85 | 0.6 | 0.45 |
| t1(mm): | 0.5 | 0.3 | 0.3 |
| t2(nm): | 0.1 | 0.6 | 1.2 |

| Surface No. & | | | | | |
|---|---|---|---|---|---|
| Radius of | Axial | | | | |
| Curvature | Distance | N1 | N2 | N3 | νd |
| r1 = ∞ | | | | | |
| | 1.000000 | 1.546061 | 1.527360 | 1.523617 | 56.0 |
| r2 = ∞ | | | | | |
| | 0.100000 | | | | |
| r3 = 1.264672 | | | | | |
| | 2.199707 | 1.637678 | 1.617521 | 1.613359 | 60.3 |
| r4 = −2.954299 | | | | | |
| | t1 | | | | |
| r5 = ∞ | | | | | |
| | t2 | 1.620403 | 1.580930 | 1.574111 | 31.0 |
| r6 = ∞ | | | | | |

Asperical Coefficients of Surface r3
K '2 −2.453603
A4 = 1.254298 × 10⁻¹
A6 = −3.871471 × 10⁻²
A8 = 2.707512 × 10⁻²
A10 = −1.204029 × 10⁻²
A12 = 2.883890 × 10⁻³
A14 = 2.034372 × 10⁻⁴
A16 = −1.909987 × 10⁻⁴
Aspherical Coefficients of Surface r4
K = −7.243150 × 10
A4 = 2.130238 × 10⁻¹
A6 = −3.754011 × 10⁻¹
A8 = 3.426509 × 10⁻¹
A10 = −1.775703 × 10⁻¹
A12 = 4.018080 × 10⁻²
A14 = 0
A16 = 0
Diffractive Coefficients of Surface r1
B2 = 1.205317 × 10⁻²
B4 = −1.396464 × 10⁻³
B6 = −1.100806 × 10⁻³
B8 = 7.618051 × 10⁻⁴
B10 = −3.422387 × 10⁻⁴
Diffractive Coefficients of Surface r2
B2 = 5.979853 × 10⁻²
B4 = −5.451861 × 10⁻³
B6 = 8.699237 × 10⁻³
B8 = −4.556232 × 10⁻³
B10 = 2.577298 × 10⁻³

1. An optical pickup apparatus comprising:
a diffractive optical element; and
an objective lens that focuses light beams of different wavelengths, namely a first wavelength λ1, a second wavelength λ2, and a third wavelength λ3, on an information recording surface formed on different types of recording medium, namely a first recording medium, a second recording medium, and a third recording medium, respectively,
the diffractive optical element comprising:
a first diffractive surface that does not diffract the light beams of the first and third wavelengths λ1 and λ3 but that diffracts the light beam of the second wavelength λ2; and
a second diffractive surface that does not diffract the light beams of the first and second wavelengths λ1 and λ2 but that diffracts the light beam of the third wavelength λ3.

2. An optical pickup apparatus as claimed in claim 1, wherein the light beams of the first, second, and third wavelengths λ1, λ2, and λ3 have increasingly long wavelengths in order of increasing number.

3. An optical pickup apparatus as claimed in claim 1, wherein the diffractive optical element has a grating portion having a step-shaped section, differences in height of individual steps thereof producing optical path differences equal to integral multiples of λ1.

4. An optical pickup apparatus as claimed in claim 1, wherein the diffractive optical element is disposed in an optical path between a light source that emits the light beams and the objective lens.

5. An optical pickup apparatus as claimed in claim 4, wherein the diffractive optical element is disposed on a light-source side of the objective lens, immediately in front of an entrance surface thereof.

6. An optical pickup apparatus as claimed in claim 4, wherein the light beams of the first, second, and third wavelengths λ1, λ2, and λ3 are all parallel beams when entering the diffractive optical element.

7. An optical pickup apparatus as claimed in claim 1, wherein the diffractive optical element makes the light beams of the second and third wavelengths λ2 and λ3 that have entered the diffractive optical element exit therefrom as divergent beams.

8. An optical pickup apparatus as claimed in claim 1, wherein the diffractive optical element is held in such a way that a position of the objective lens relative thereto remains fixed.

9. An optical pickup apparatus as claimed in claim 1, wherein the diffractive optical element is of a continuous type in which any two adjacent level surfaces differ in height only by one step.

10. An optical pickup apparatus as claimed in claim 1, wherein the diffractive optical element is of a sawtooth type in which, every predetermined number of level surfaces of which each differs in height by one step from a next, level surfaces are shifted back by a corresponding number of steps.

11. An optical disk apparatus comprising:
a light source that oscillates light beams of different wavelengths, namely a first wavelength λ1, a second wavelength λ2, and a third wavelength λ3;
a light integrator that makes the light beams of the first, second, and third wavelengths λ1, λ2, and λ3 exit therefrom in such a way as to proceed to travel along an common optical path;
a diffractive optical element; and
an objective lens that focuses the light beams of the first, second, and third wavelengths λ1, λ2, and λ3 on an information recording surface formed on different types of recording medium, namely a first recording medium, a second recording medium, and a third recording medium, respectively,
the diffractive optical element comprising:
a first diffractive surface that does not diffract the light beams of the first and third wavelengths λ1 and λ3 but that diffracts the light beam of the second wavelength λ2; and
a second diffractive surface that does not diffract the light beams of the first and second wavelengths λ1 and λ2 but that diffracts the light beam of the third wavelength λ3.

12. An optical disk apparatus as claimed in claim 11, wherein the light beams of the first, second, and third wavelengths λ1, λ2, and λ3 have increasingly long wavelengths in order of increasing number.

13. An optical disk apparatus as claimed in claim 11, wherein the diffractive optical element has a grating portion having a step-shaped section, differences in height of individual steps thereof producing optical path differences equal to integral multiples of λ1.

14. An optical disk apparatus as claimed in claim 11, wherein the diffractive optical element is disposed in an optical path between the light source that emits the light beams and the objective lens.

15. An optical disk apparatus as claimed in claim 14, wherein the diffractive optical element is disposed on a light-source side of the objective lens, immediately in front of an entrance surface thereof.

16. An optical disk apparatus as claimed in claim 14, wherein the light beams of the first, second, and third wavelengths λ1, λ2, and λ3 are all parallel beams when entering the diffractive optical element.

17. An optical disk apparatus as claimed in claim 11, wherein the diffractive optical element makes the light beams of the second and third wavelengths λ2 and λ3 that have entered the diffractive optical element exit therefrom as divergent beams.

18. An optical disk apparatus as claimed in claim 11, wherein the diffractive optical element is held in such a way that a position of the objective lens relative thereto remains fixed.

19. A diffractive optical element disposed in an optical path of an optical pickup apparatus, comprising:
a first diffractive surface that does not diffract light beams of first and third wavelengths λ1 and λ3 but that diffracts a light beam of a second wavelength λ2; and
a second diffractive surface that does not diffract light beams of first and second wavelengths λ1 and λ2 but that diffracts a light beam of a third wavelength λ3.

20. A diffractive optical element as claimed in claim 19, wherein the light beams of the first, second, and third wavelengths λ1, λ2, and λ3 have increasingly long wavelengths in order of increasing number.

21. A diffractive optical element as claimed in claim 19, wherein the diffractive optical element has a grating portion having a step-shaped section, differences in height of individual steps thereof producing optical path differences equal to integral multiples of λ1.

22. A diffractive optical element as claimed in claim 19, wherein the light beams of the first, second, and third wavelengths λ1, λ2, and λ3 are all parallel beams when entering the diffractive optical element.

23. A diffractive optical element as claimed in claim 19, wherein the diffractive optical element makes the light beams of the second and third wavelengths λ2 and λ3 that have entered the diffractive optical element exit therefrom as divergent beams.

24. A diffractive optical element as claimed in claim 19, wherein the diffractive optical element is of a continuous type in which any two adjacent level surfaces differ in height only by one step.

25. A diffractive optical element as claimed in claim 19, wherein the diffractive optical element is of a sawtooth type in which, every predetermined number of level surfaces of which each differs in height by one step from a next, level surfaces are shifted back by a corresponding number of steps.
